(19) United States
(12) Patent Application Publication
(10) Pub. No.: US 2020/0007571 A1
(43) Pub. Date: Jan. 2, 2020

(54) WEB-BASED SS7 VULNERABILITY SCANNING AND NOTIFICATION APPARATUS AND METHOD THEREOF

(71) Applicant: The Telecom Defense Limited Company, Las Vegas, NV (US)

(72) Inventor: Johannes Gottschalk, Las Vegas, NV (US)

(73) Assignee: The Telecom Defense Limited Company, Las Vegas, NV (US)

(21) Appl. No.: 16/558,613

(22) Filed: Sep. 3, 2019

(51) Int. Cl. H04L 29/06

(52) U.S. Cl. CPC H04L 63/1433

(57) ABSTRACT

The present disclosure relates web-based vulnerability scanning and notification apparatus and method thereof. In an embodiment, an automated vulnerability scanning and notification apparatus for testing an attack vulnerability of a SS7 network is disclosed. The apparatus includes a processor, and one or more stored sequences of instructions to be executed by the processor. Upon execution of the instructions, the processor is caused to generate 308 one or more packets towards an external interface of the network, test 310 the vulnerability of the network based at least on said one or more generated packets and one or more pre-determined test criteria pre-stored in the memory, and test 312 if one or more pre-determined filtering rules are triggered based at least on said one or more generated packets.

### TECHNICAL FIELD

The present disclosure relates to a system and method for detecting intrusion into, and for assessing the vulnerability of, a telecommunications network, typically implemented as Signaling System 7 (SS7), and more particularly, to web-based automated vulnerability scanning and notification apparatus and method thereof.

### BACKGROUND

Background description includes information that may be useful in understanding the present invention. It is not an admission that any of the information provided herein is prior art or relevant to the presently claimed invention, or that any publication specifically or implicitly referenced is prior art.

Signaling System 7 (SS7) is an international telecommunications standard that defines how network elements in a public switched telephone network (PSTN) and/or mobile networks to exchange information over a digital signaling network. Nodes in an SS7 network are called signaling points. SS7 is a standard established and maintained by the American National Standards Institute (ANSI) defining procedures and protocols used by network elements to exchange data for call setup, routing and control (e.g., ISUP messages and CAP messages), for the exchange of non-circuit related information between signaling points (e.g., transactional TCAP messages) and for the facilitation of roaming on mobile operator network (e.g. CAP messages). SS7 messages are historically transmitted between network elements, known as signaling points (SP) using 56 or 64 kbps bidirectional channels called signaling links. SPs include Service Switching Points (SSPs), Signal Transfer Points (SIPs), and Service Control Points (SCRs). SSPs are the switches that originate, terminate, or route (i.e., “tandem”) SCPs provide centralized databases and support other centralized call processing functions required by special services (e.g., 800 numbers, enhanced call forwarding services, prepaid billing services in mobile network, etc.) SCPs may be queried by an SSP using TCAP to obtain call routing and call handling information, or by mobile network nodes using MAP. The STPs route these network control messages over the SS7 network between and among the SSPs and SCPs as necessary.

An SS7 attack is an exploit that takes advantage of a weakness in the design of SS7 to enable data theft, eavesdropping, text interception and location tracking.

At each signaling point of a Signaling System 7 (SS7) network is some type of computer element that has a network card connecting the point to the network. These network cards are designed to operate in accordance with the SS7 protocol, which defines standards for communication between signaling points. Also, nowadays the computer element may also connect to SS7 via SIGTRAN which is SS7 over IP, such that no dedicated SS7 link card is needed, but the packets can be transported over a regular Ethernet link. Among those signaling points are Signal Transfer Points (STPs). These are switching elements of SS7 networks that route SS7 packets between network endpoints. Signal Transfer Points perform signal routing, packet integrity controls and routing analysis of SS7 packets.

Signal Transfer Points are essentially network routers which do not have sophisticated packet-filtering processors and thus have limited inherent security capabilities. This makes Signal Transfer Points vulnerable to attacks and various network vulnerabilities. Packets known to be, or at least suspected of, carrying attacks or constituting other kinds of threats are referred to herein as “malicious” packets.

With the advent of a liberalized interconnection environment, necessitated by an open network architecture, the interfaces between networks have been identified as points of vulnerability through which network impairing problems can be introduced. Such problems may be caused by unintentionally misdirected or erroneous messaging being introduced into a LEC's or mobile operator's SS7 network at a point of interconnection or nefariously introduced messaging used to obtain unauthorized access to network facilities or to undermine network operations. To prevent improper and unauthorized access to the SS7 system, LECs and mobile operators have instituted specialized interfaces with other networks. These interfaces are commonly known as signaling mediation points, gateway screening systems or signaling system gatekeepers.

Telcordia Technologies (previously Bellcore) Generic Requirements document number GR-82-CORE provides requirements for STPs, used within signaling networks to connect network SPs to each other and to SPs in other networks. Traditional Gateway screening, defined in GR-82-CORE, facilitates the specification of specific messages that will be permitted into the network, based on message structure and the linkset on which the messages arrive. This screening is typically implemented using custom static tables created by the network operator. For example, traditional Gateway screening can be used to allow the transmission of all Transfer Prohibit (TFP) messages from a given Originating Point Code (OPC), addressed to a given Destination Point Code (DPC), and concerning a predesignated third Point Code (PC) into the network. These requirements were used by STP vendors to implement Gateway Screening between interconnected SS7 networks. Subsequently, various manufacturers have produced interface products known as SS7/IP Signaling Gateways (SGs) to interconnect SS7 signaling protocol with Internet Protocol (IP) based networks, such as the Internet. Commercially available equipment includes the MicroLegend SS7/TP Signaling Gateway, Ascend Signaling Gateway (ASG), Nuvo AIN platform SS7 Signaling Gateway by Mockingbird Networks, SGX2000 SS7 Signaling Gateway by Scums Technologies, and others. In addition to performing protocol conversion between SS7 (and other CCS variants) and IP signaling, these Gateways may include a gateway screening function. Gateway screening, sometimes referred to as mediation, includes the selective control of signaling messages passed between networks based on parameters such as message origination and destination point codes, called and calling party addresses, etc. Thus, message header information may be examined to check whether a message is appropriate prior to routing.

While these systems and methods mediate between diverse remote networks and a LECs or mobile operator's SS7 network by checking information related to routing, the systems fail to provide a level of security that would protect the LECs or mobile operator's SS7 and the PSTN or mobile core network (of which it is a part) from properly formatted and addressed but otherwise improper messages. This message validity checking, according to the prior art, is further deficient in its inability to readily accommodate messages received from sources wherein message origination information may be difficult to verify e.g. messages received from distant, non-contiguous LEC's, mobile operators, non-licensed service providers, etc. Considering that these messages may originate on and/or be transported by relatively insecure networks including, for example, the public Internet, the problem of providing access while limiting any resultant threat to the PSTN caused by spurious, erroneous, or malicious messages is made more difficult. Finally, the prior art is deficient in that it fails to examine the context in which a message is received. Messages which are appropriate at one point in a call or transaction may be inappropriate under other conditions, depending either on the state of the call or transaction, or on the specific data elements passed in prior stages of the call or transaction.

Therefore, there exists a need to, provide a vulnerability scanner that requires no physical deployment, connectivity or infrastructure in a customer network, and provides a realistic approach by ensuring that all SS7 messages reach the network through external international roaming connections.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### SUMMARY

Most mobile operators do not have the capabilities to generate SS7 signaling traffic towards the external interfaces of the mobile network, as this would require connectivity to foreign global titles in addition to specialized software. This makes it difficult to test any filters applied onto the operator's STP, mobile nodes or SS7 firewall, and makes it more difficult to construct and apply filters without affecting live subscriber traffic.

Besides making it easier for user to create and test effective rules to fend off SS7 attacks, the present invention allows properly trained audit staff to conduct sporadic assessments of the network's defenses.

The present disclosure relates generally to detecting vulnerabilities, and more particularly, to web-based automated vulnerability scanning and notification apparatus and method thereof.

Accordingly, the present invention provides web-based software as a service which addresses this requirement without any physical integration required with the mobile network.

In an aspect, the present invention provides a web based solution allowing users to generate adhoc signaling messages towards their mobile network, in order to test defenses against common SS7-based threats. The present invention includes access to a user interface (which can be accessed using any web-browser, an Internet connection and valid user credentials) from which SS7 commands can be formatted and sent, as well as behind the scenes SS7 connectivity including use of a global title from a valid roaming partner that allows successful delivery of signaling messages towards the mobile network's SS7 nodes.

In another aspect, the SS7 messages will reach the operator from the external interfaces of its SCCP carriers, just as real attackers' traffic would, and will accurately test any filtering rules or defences in place on the network, including existing SS7 firewalls.

In another aspect, the present invention enables the user to test network defences against the GSMA defined Category 1, Category 2 and Category 3 vulnerabilities.

In another aspect, the present invention enables the user to test below scenarios:
✓ Leaking of IMSIs (GSMA Category 1 vulnerability)
✓ Leaking of location information (GSMA Category 1 vulnerability, as demonstrated on 60 Minutes Australia).
✓ Call interception (GSMA Category 2 vulnerability, as demonstrated on 60 Minutes USA).
✓ Call forwarding (bank fraud) (GSMA Category 2 vulnerabilities).
✓ Toll and billing fraud (GSMA Category 2 vulnerabilities).
✓ USSD fraud, spam and fishing (GSMA Category 2 vulnerability).
✓ Disruption of a subscriber's services (GSMA Categories 2 and 3 vulnerabilities).
✓ Capturing of inbound SMS messages (GSMA Category 3 vulnerability, as demonstrated on 60 Minutes Australia).
✓ Wholesale SMS fraud (GSMA Category 3 vulnerability).
✓ 3G IMSI catchers (GSMA Category 3 vulnerability).
✓ SCCP spoofing and any other vulnerabilities yet to be discovered

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

In the figures, similar components author features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates exemplary block diagram of an example environment in which an automated vulnerability scanning and notification apparatus can be used according to some implementations.

FIG. 2 illustrates an exemplary block diagram of the automated vulnerability scanning and notification apparatus, in accordance with an exemplary embodiment of the present disclosure.

FIG. 3 illustrates exemplary functional modules of the automated vulnerability scanning and notification apparatus, in accordance with an exemplary embodiment of the present disclosure.

FIG. 4 illustrates an exemplary method of working of the automated vulnerability scanning and notification apparatus, in accordance with an exemplary embodiment of the present disclosure.

FIG. 5 illustrates an exemplary computer system utilized for implementation of the automated vulnerability scanning and notification apparatus in accordance with an exemplary embodiment of the present disclosure.

FIG. 6 illustrates exemplary connectivity architecture of the cloud scanner showing how messages are sent over the SS7 network using external SS7 connectivity and external global title in accordance with an exemplary embodiment of the present disclosure.

### DETAILED DESCRIPTION

Embodiments of the present disclosure include various steps, which will be described below. The steps ray be performed by hardware components or may be embodied in machine-executable instructions, which may be used to cause a general-purpose or special-purpose processor programmed with the instructions to perform the steps. Alternatively, steps may be performed by a combination of hardware, software, and firmware or by human operators.

The following detailed description is made with reference to the technology disclosed. Preferred implementations are described to illustrate the technology disclosed, not to limit its scope, which is defined by the claims. Those of ordinary skill in the art will recognize a variety of equivalent variations on the description.

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some implementations described and referenced herein are directed to systems, apparatus, computer-implemented methods and computer-readable storage media for detecting flooding of message queues.

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any electronic code generator shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Various terms as used herein are shown below. To the extent a term used in a claim is not defined below, it should be given the broadest definition persons in the pertinent art have given that term as reflected in printed publications and issued patents at the time of filing.

Although the present disclosure has been described with the purpose of implementing automated vulnerability scanning and notification apparatus and method, it should be appreciated that the same has been done merely to illustrate the invention in an exemplary manner and any other purpose or function for which the explained structure or configuration can be used, is covered within the scope of the present disclosure.

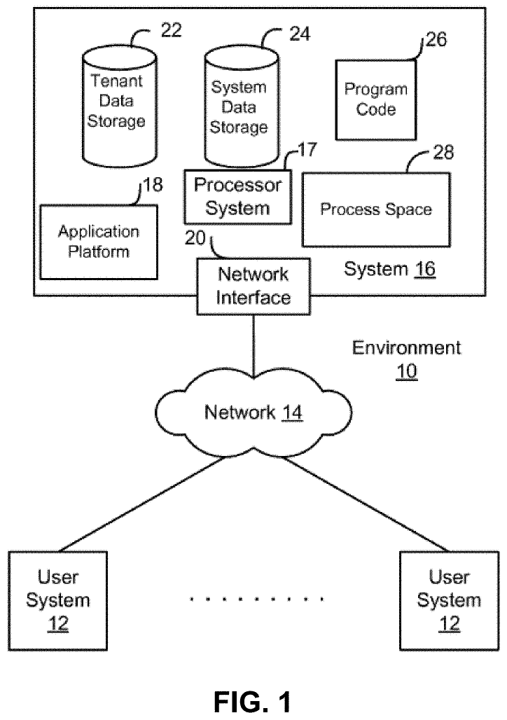

FIG. 1 illustrates exemplary block diagram of an example environment in which an automated vulnerability scanning and notification apparatus can be used according to some implementations.

FIG. 1 shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications. Applications may be developed by the provider of the on-demand database service, by users accessing the on-demand database service via user systems 12, or by third party application developers accessing the on-demand database service via user systems 12.

In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The application platform 18 manages the creation and storage of the applications into one or more database objects and the execution of the applications in one or more virtual machines in the process space of the system 16.

According to some implementations, each system 16 may be configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in sonic instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a wearable device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 1 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), micro drives, and magneto-optical disks, and magnetic or optical cards, Nano systems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

In an exemplary embodiment, the present invention is configured to generate a result as a notification to the user after a message is sent over the network for vulnerability check.

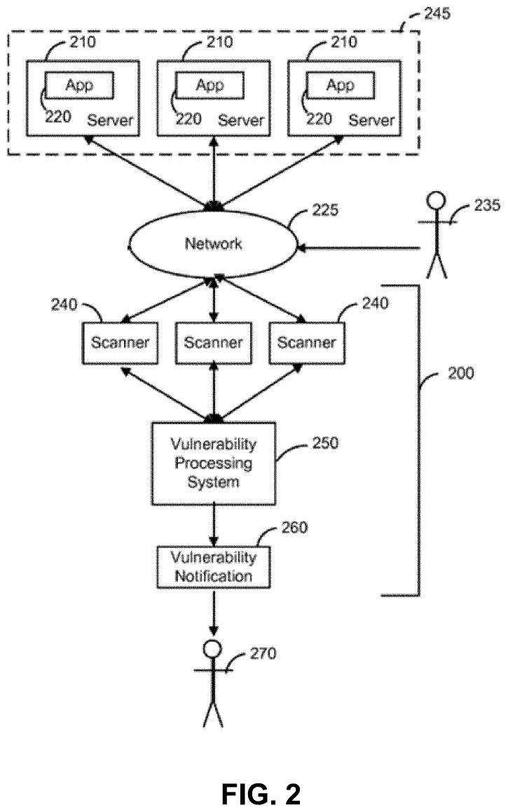

FIG. 2 illustrates an exemplary block diagram of the automated vulnerability scanning and notification apparatus, in accordance with an exemplary embodiment of the present disclosure.

FIG. 2 is a block diagram of an automated software vulnerability scanning and notification system 200 that provides automated scanning of network-based web-based) servers 210 and applications 220 to identify and provide notification of software-based information-security vulnerabilities, weaknesses, or exposures (referred to herein collectively as vulnerabilities). Such vulnerabilities may be listed and updated in publicly-available vulnerability database 230 such as, for example, the CVE® Common Vulnerabilities and Exposures system or the CWE Common Weakness Enumeration system, both maintained by MITRE Corporation as dictionaries, libraries, or databases of publicly known information-security software vulnerabilities, or any other dictionary, library, or database information-security software vulnerabilities. Optionally, vulnerability information in vulnerability database 230 may be supplemented manually by a software vulnerability engineer to include updated vulnerability information.

Servers 210 and applications 220 may be independently available on and accessible from a computer network 225, such as the Internet, or may be included in a cloud-based tenant database system 245 of a type similar to tenant database system 16 of FIGS. 1A and 1B such as, for example, the Independent Software Vendors (“ISVs”) in the AppExchange program of Salesforce.com, Inc. For purposes of illustration, each of servers 210 is illustrated as including one application 220. It will be appreciated that each server 210 could include one or more applications 220.

Vulnerability scanning and notification system 200 includes one or more network-based (e.g., cloud-based) scanners 240 that scan servers 210 and applications 220 to identify software types and versions operating on servers 210 and included in applications 220. For example, scanners 240 may determine any or all of:
SSL Library and Cryptographic Keys
   E.g. OpenSSL, GNUTLS, Mozilla NSS, Java JSSE, MS SChannel Server OS
   E.g. Apache, Tomcat, HP, IBM, Nginx, OS X, MS Server, Thin, Flask
Ancillary Server Software Installed
Programming Languages in Use
   E.g. PHP, Ruby, etc.
Application Frameworks
   E.g. Drupal, Wordpress, Joomla, Rails
Common software plugins and additions
   E.g. Timthumb, image magik, Wordpress plugins, CKEditor, TinyMCE, et. al.
Relational Database System software
   E.g. MySQL, Postgres, MSSQL
Database Caching software
JS libraries in UI
   E.g. Prototype, jQuery
Web Application Firewalls (WAF's)
Load Balancers
   E.g. F5, A10, NetScaler, Riverbed, Cisco ACE
Hosting Providers
   E.g. Amazon AWS, Netflare
Partially Installed Software (which can also in and Of itself be a vulnerability) In one implementation, scanners 240 may be implemented with a conventional network mapping, tool such as, for example, the Nmap Network Mapper, an open source utility for network discovery and security auditing available from nmap.org. In addition or alternatively, scanners 240 may employ any or all of the following detection mechanisms to determine information about the types and version of software on servers 210 and in applications 220:
Response Headers and Header Ordering
Port Scanning
syn/ack and hello messages
IP-based fingerprinting technologies
Defined IP ranges
Response Body heuristics
   Javascript include tags
   Common error stack traces/messages
Default pages/resources
Default Server Responses
Protocol Behavior
Malformed Request/Systematic Errors/Mistakes
Improper Version or Protocol Responses
Statistical Analysis
Signature Analysis

Scanners 240 provide the information about the software types and versions of servers 210 and applications 220 to a vulnerability processing system 250, which is also in communication with vulnerability database 230 and includes a record identifying the operators of servers 210 and applications 220. For example, scanners 240 may scan servers 210 and applications 220 periodically (e.g., weekly or monthly) to identify software types and versions used on servers 210 and in applications 220, and vulnerability processing system 250 may store the results of the scans over time in association with the record of the corresponding operators. In connection with the results of each scan, for example, vulnerability processing system 250 compares the scan results with the records of vulnerability database 230 to identify any vulnerability for the scanned server 210 or application 220.

Upon identifying vulnerability, vulnerability processing system 250 transmits a notification message 260 to the corresponding operator 270. The message may be transmitted in any computer-based communication format, including email or a dedicated messaging system associated with vulnerability scanning and notification system 200. The message may include identification of the vulnerable software type and version, as well as a suggested remediation such as updating the version of the vulnerable software. In one implementation, the notification message 260 may be provided on a network or web portal that is associated with cloud-based tenant database system 245, for example, and may provide the operator with any or all of: information about detected vulnerabilities and remediation steps, viewing of vulnerability scan results, launching of vulnerability scans, viewing current performance or usage information about the application, and tools to update the application.

In an exemplary embodiment, the present invention is configured to generate a result as a notification to the user after a message is sent over the network for vulnerability check.

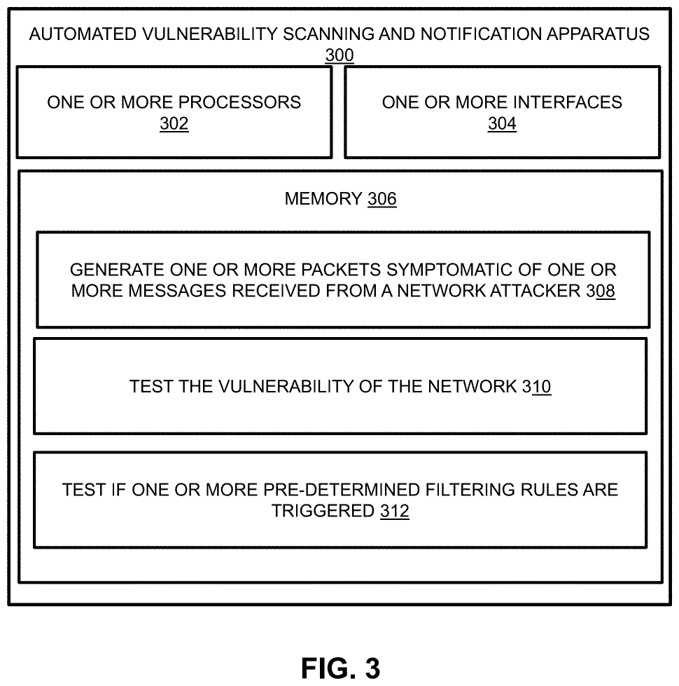

FIG. 3 illustrates exemplary functional modules of the automated vulnerability scanning and notification apparatus, in accordance with an exemplary embodiment of the present disclosure.

FIG. 3 illustrates exemplary functional modules of the automated vulnerability scanning and notification apparatus 300, in accordance with an exemplary embodiment of the present disclosure. In one embodiment, the automated vulnerability scanning and notification apparatus 300 may include one or more processors 302, an input/output (I/O) interface 304, and a memory 306. Each of the one or more may be implemented as one or more microprocessors, microcomputers, microcontrollers, digital signal processors, central processing units, state machines, logic circuitries, and/or any devices that manipulate signals based on operational instructions. Among other capabilities, each of the one or more processors 302 is configured to fetch and execute computer-readable instructions stored in the memory 306.

The I/O interface 304 may include a variety of software and hardware interfaces, for example, a web interface, a graphical user interface, and the like. The I/O interface 204 may allow the automated vulnerability scanning and notification apparatus 300 to interact with a user directly or through the client/computing devices. Further, the I/O interface 304 may enable the automated vulnerability scanning and notification apparatus 300 to communicate with other computing devices, such as web servers and external data servers. The I/O interface 304 can facilitate multiple communications within a wide variety of networks and protocol types, including wired networks, for example, LAN, cable, etc., and wireless networks, such as WLAN, cellular, or satellite. The I/O interface 304 may include one or more ports for connecting a number of devices to one another or to another server.

The memory 306 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 306 may include modules, routines, programs, objects, components, data structures, etc., which perform particular tasks or implement particular abstract data types.

In an embodiment, an automated vulnerability scanning and notification apparatus for testing an attack vulnerability of a network is disclosed.

In an exemplary embodiment, the apparatus includes a processor, and one or more stored sequences of instructions to be executed by the processor. Upon execution of the instructions, the processor is caused to generate 308 one or more packets towards an external interface of the network, test 310 the vulnerability of the network based at least on said one or more generated packets and/or one or more pre-determined test criteria pre-stored in the memory, and test 312 if one or more pre-determined filtering rules are triggered based at least on said one or more generated packets.

In an exemplary embodiment, the one or more packets symptomatic of one or more messages received by the network from a network attacker.

In an exemplary embodiment, the attack vulnerability is associated with a signaling system 7 (SS7) attack.

In an exemplary embodiment, the apparatus is a web-based signaling system 7 (SS7) penetration testing tool accessible through an interne browser and provides one or more SS7 connectivity.

In an exemplary embodiment, the apparatus requires no deployment, no connectivity or no infrastructure in the network.

In an exemplary embodiment, the apparatus is configured to generate an automated notification associated with the testing of attack vulnerability.

In an exemplary embodiment, the apparatus is configured to periodically scan the network to test the attack vulnerability.

In an exemplary embodiment, the one or more generated packets are configured to deliver to the network at least through its signaling connection control part (SCCP) carrier of a protocol.

In an exemplary embodiment, the one or more generated packets are further configured to traverse at least through one or more filtering rules of the network.

In an exemplary embodiment, the apparatus is configured to generate, in real-time, one or more software wizards to automatically suggest at least an appropriate signaling connection control part (SCCP) subsystem numbers (SSNs) and mobile application part (MAP) versions for the one or more generated packets.

In an exemplary embodiment, the suggested at least an appropriate signaling connection control part (SCCP) subsystem numbers (SSNs) or the suggested mobile application part (MAP) versions, if selected, from the one or more software wizards are saved.

In an exemplary embodiment, one or more packets are one or more commands provided by a user.

In another embodiment, an automated vulnerability scanning and notification apparatus for testing an attack vulnerability of a network is disclosed.

In an exemplary embodiment, a processor, and one or more stored sequences of instructions to be executed by the processor. Upon execution of the instructions, the processor is caused to generate 308 one or more packets towards an external interface of the network, test 310 the vulnerability of the network based at least on said one or more generated packets, or test 312 if one or more pre-determined filtering rules are triggered based at least on said one or more generated packets.

In an exemplary embodiment, the apparatus requires no deployment, connectivity or infrastructure in the customer network, and provides a realistic approach by ensuring that all SS7 messages reach the network through external international roaming connections.

In an exemplary embodiment, the apparatus allows mobile networks to generate SS7 messages towards the external interface of their networks, in order to accurately simulate messages from an attacker, and conclusively verify if vulnerabilities exist and/or if filtering rules are triggering. The SS7 messages reach the network through its SCCP carrier, and traverse all potential SS7 defenses just like messages from real attackers would. Unlike ruleset simulators or network internal traffic generators, this provides a fully reliable and conclusive way to test defenses

In an exemplary embodiment, the apparatus is a web-based and accessible through a standard Internet browser, and provides all SS7 connectivity, including global title identities from appropriate roaming partner sponsors, to generate incoming SS7 messages towards a mobile network.

In an exemplary embodiment, the present invention is configured to generate a result as a notification to the user after a message is sent over the network for vulnerability check.

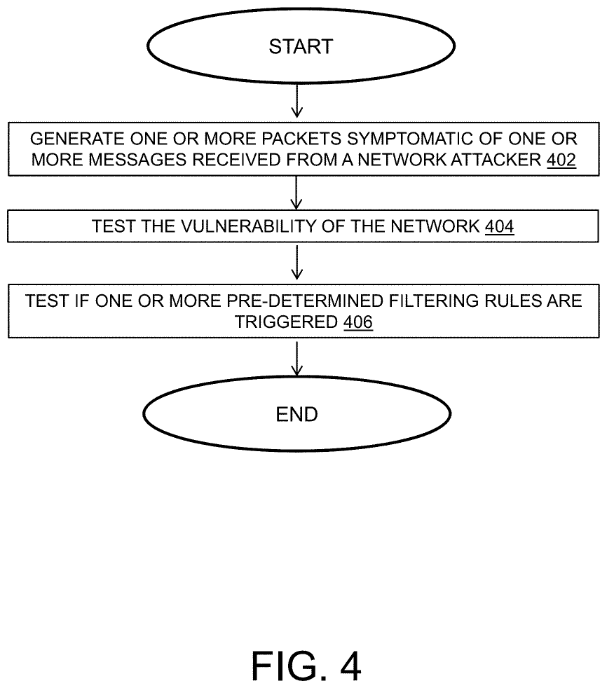

FIG. 4 illustrates an exemplary method of working of the automated vulnerability scanning and notification apparatus, in accordance with an exemplary embodiment of the present disclosure. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the protection scope of the subject matter described herein. Furthermore, the method can be implemented in any suitable hardware, software, firmware, or combination thereof. However, for ease of explanation, in the embodiments described below, the method may be considered to be implemented in the above the proposed automated vulnerability scanning and notification apparatus 300.

At step 402, the automated vulnerability scanning and notification apparatus 300 generates one or more packets towards an external interface of the network. The one or more packets symptomatic of one or more messages receive by the network from a network attacker.

At step 404, the automated vulnerability scanning and notification apparatus 300 tests the vulnerability of the network based at least on said one or more generated packets and one or more pre-determined test criteria.

At step 404, the automated vulnerability scanning and notification apparatus 300 tests if one or more pre-determined filtering rules are triggered based at least on said one or more generated packets.

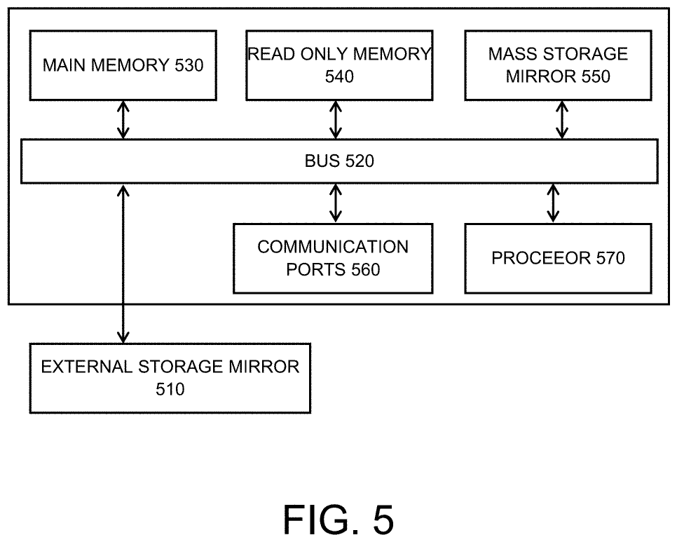

FIG. 5 illustrates an exemplary computer system utilized for implementation of the vulnerability scanning and notification apparatus in accordance with an exemplary embodiment of the present disclosure.

In an embodiment, the proposed the automated vulnerability scanning and notification apparatus 300 can be implemented in the computer system to enable aspects of the present disclosure. Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown in the FIG. 5, the computer system includes an external storage device 510, a bus 520, a main memory 530, a read only memory 540, a mass storage device 550, communication port 560, and a processor 570. A person skilled in the art will appreciate that computer system may include more than one processor and communication ports. Examples of processor 570 include, but are not limited to, an Intel® Itanium® or Itanium 2 processor(s), or AMD® Opteron® or Athlon MP® processor(s), Motorola® lines of processors, FortiSOC™ system on a chip processors or other fixture processors. Processor 570 may include various modules associated with embodiments of the present invention. Communication port 560 can be any of an RS-232 port for use with a modem based dialup connection, a 10/100 Ethernet port, a Gigabit or 10 Gigabit port using copper or fiber, a serial port, a parallel port, or other existing or future ports. Communication port 560 may be chosen depending on a network, such a Local Area Network (LAN), Wide Area Network (WAN), or any network to which computer system connects. Memory 530 can be Random Access Memory (RAM), or any other dynamic storage device commonly known in the art. Read only memory 540 can be any static storage device(s) e.g., but not limited to, a Programmable Read Only Memory (PROM) chips for storing static information e.g., start-up or BIOS instructions for processor 570. Mass storage 550 may be any current or future mass storage solution, which can be used to store information and/or instructions. Exemplary mass storage solutions include, but are not limited to, Parallel Advanced Technology Attachment (DATA) or Serial Advanced Technology Attachment (SAT) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc. Bus 820 communicatively couples processor(s) 470 with the other memory, storage and communication blocks. Bus 520 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 570 to software system. Optionally, operator and administrative interfaces, e.g. a display, keyboard, and a cursor control device, may also be coupled to bus 520 to support direct operator interaction with computer system. Other operator and administrative interfaces can be provided through network connections connected through communication port 560. External storage device 510 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM). Components described above are meant only to exemplify various possibilities. In no way should the aforementioned exemplary computer system limit the scope of the present disclosure.

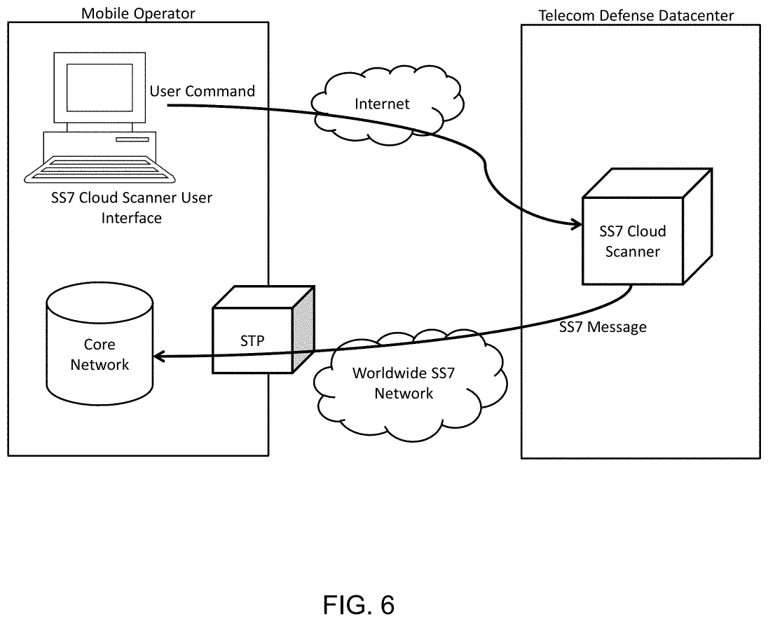

FIG. 6 provides exemplary connectivity architecture of the cloud scanner showing how messages are sent over the SS7 network using external SS7 connectivity and external global title in accordance with an exemplary embodiment of the present disclosure.

Most mobile operators do not have the capabilities to generate SS7 signaling traffic towards the external interfaces of the mobile network, as this would require, connectivity to foreign global titles in addition to specialized software. This makes it difficult to test any filters for malicious SS7 messages applied onto the operator's STP, mobile nodes or SS7 firewall, and makes it more difficult to construct and apply filters without affecting live subscriber traffic.

Besides making it easier for the user to create and test effective rules to fend off SS7 attacks, the present invention allows properly trained audit staff to conduct sporadic assessments of the network's defenses.

The present disclosure relates provides a web-based external SS7 vulnerability scanning and notification apparatus and method thereof.

Accordingly, the present invention provides web-based software as a service which addresses this requirement without any physical integration required with the mobile network or any SS7 connectivity.

In an embodiment, the present invention provides a web based solution allowing users to generate adhoc signaling messages towards their mobile network, in order to test defenses against common SS7-based threats. The present invention includes access to a user interface (which can be accessed using any web-browser, an Internet connection and valid user credentials) from which SS7 commands can be formatted and sent, as well as behind the scenes SS7 connectivity including use of a global title from a valid roaming partner of the network that allows successful delivery of signaling messages towards the mobile network's SS7 nodes.

In an exemplary embodiment, the SS7 messages will reach the operator from the external interfaces of its SCCP carriers, just as real attackers' traffic would, and will accurately test any filtering rules or defences in place on the network, including existing SS7 firewalls.

In another exemplary embodiment, the present invention enables the user to test network defences against the GSMA defined Category 1, Category 2 and Category 3 vulnerabilities.

In an exemplary embodiment the software vulnerability scanning and notification system according to present invention provides external scanning of network-based (e.g., web-based) servers and applications to identify and provide notification of software-based information-security vulnerabilities, weaknesses, or exposures (referred to herein collectively as vulnerabilities).

Servers and applications may be independently available on and accessible from a computer network, such as the Internet. Vulnerability scanning and notification system includes one or more network-based (e.g., cloud-based) scanners that scan servers and applications to identify software types and versions operating on servers and included in applications.

Upon identifying vulnerability, vulnerability processing system can transmit a notification message to the corresponding operator. The message may be transmitted in any computer-based communication format, including email or a dedicated messaging system associated with vulnerability scanning and notification system. The message may include identification of the vulnerable node (identified by Global Title), as well as a suggested remediation such as updating SS7 firewall rules. In one implementation, the notification message may be provided on a network or web portal that is associated with cloud-based tenant database system, for example, and may provide the operator with any or all of: information about detected vulnerabilities and remediation steps, viewing of vulnerability scan results, launching of vulnerability scans, viewing current performance or usage information about the application, and tools to update the application

Although the proposed system has been elaborated as above to include all the main modules, it is completely possible that actual implementations may include only a part of the proposed modules or a combination of those or a division of those into sub-modules in various combinations across multiple devices that can be operatively coupled with each other, including in the cloud. Further the modules can be configured in any sequence to achieve objectives elaborated. Also, it can be appreciated that proposed system can be configured in a computing device or across a plurality of computing devices operatively connected with each other, wherein the computing devices can be any of a computer, a laptop, a smartphone, an Internet enabled mobile device and the like. All such modifications and embodiments are completely within the scope of the present disclosure.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean communicatively “coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the protection scope of the appended claims.

What is claimed is:

1. An vulnerability scanning and notification apparatus for testing an attack vulnerability of a network, the apparatus comprising:
a processor; and
one or more stored sequences of instructions which, when executed by the processor, cause the processor to:
generate one or more packets towards an external interface of the network, wherein the one or more packets symptomatic of one or more messages received by the network from a network attacker; and thereby
test the vulnerability of the network based at least on said one or more generated packets test if one or more pre-determined filtering rules are triggered based at least on said one or more generated packets.

2. The vulnerability scanning and notification apparatus of claim 1, wherein the attack vulnerability is associated with a signaling system 7 (SS7) attack.

3. The vulnerability, scanning and notification apparatus of claim 1, wherein the apparatus is a web-based signaling system 7 (SS7) penetration testing tool accessible through an interact browser and provides one or more SS7 connectivity.

4. The vulnerability scanning and notification apparatus of claim 1, wherein the apparatus requires no deployment, no connectivity or no infrastructure in the network.

5. The vulnerability scanning and notification apparatus of claim 1, wherein the apparatus is configured to generate an automated notification associated with the testing of attack vulnerability.

6. The vulnerability scanning and notification apparatus of claim 1, wherein the apparatus is configured to periodically scan the network to test the attack vulnerability.

7. The vulnerability scanning and notification apparatus of claim 1, wherein the one or more generated packets are configured to deliver to the network at least through its signaling connection control part (SCCP) carrier of a protocol.

8. The vulnerability scanning and notification apparatus of claim 7, wherein the one or more generated packets are further configured to traverse at least through one or more filtering rules of the network.

9. The vulnerability scanning and notification apparatus of claim 1, wherein the apparatus is configured to generate, in real-time, one or more software wizards to automatically suggest at least an appropriate signaling connection control part (SCCP) subsystem numbers (SSNs) and mobile application part (MAP) versions for the one or more generated packets.

10. The vulnerability scanning and notification apparatus of claim 9, wherein the suggested at least an appropriate signaling connection control part (SCCP) subsystem numbers (SSNs) or the suggested mobile application part (MAP) versions, if selected, from the one or more software wizards are saved.

11. The vulnerability scanning and notification apparatus of claim 1, wherein the one or more packets are one or more commands provided by a user.

12. An vulnerability scanning and notification apparatus for testing an attack vulnerability of a network, the apparatus comprising:
a processor; and
one or more stored sequences of instructions which, when executed by the processor, cause the processor to:
generate one or more packets towards an external interface of the network, wherein the one or more packets symptomatic of one or more messages receive by the network front a network attacker; and thereby
test the vulnerability of the network based at least on said one or more generated packets; or
test if one or more pre-determined filtering rules are triggered based at least on said one or more generated packets.

13. A computer implemented method for testing an attack vulnerability of a network, the computer implemented method comprising:
generating one or more packets towards an external interface of the network, wherein the one or more packets symptomatic of one or more messages receive by the network from a network attacker; and thereby
testing the vulnerability of the network based at least on said one or more generated packets; and
testing if one or more pre-determined filtering rules are triggered based at least on said one or more generated packets.

14. The computer implemented method of claim 13, wherein the attack vulnerability is associated with a signaling system 7 (SS7) attack, and requires no deployment, no connectivity or no infrastructure in the network.

15. The computer implemented method of claim 13, wherein the apparatus is a web-based signaling system 7 (SS7) penetration testing tool accessible through an internet browser and provides one or more SS7 connectivity.

16. The computer implemented method of claim 13, wherein the apparatus is configured to generate an automated notification associated with the testing of attack vulnerability.

17. The computer implemented method of claim 13, wherein the apparatus is configured to periodically scan the network to test the attack vulnerability.

18. The computer implemented method of claim 13, wherein the one or more generated packets are configured to deliver to the network at least through its signaling connection control part (SCCP) carrier of a protocol, and wherein the one or more generated packets are further configured to traverse at least through one or more filtering rules of the network.

19. The computer implemented method of claim 13, wherein the apparatus is configured to generate, in real-time, one or more software wizards to automatically suggest at least an appropriate signaling connection control part (SCCP) subsystem numbers (SSNs) and mobile application part (MAP) versions for the one or more generated packet; and
wherein the suggested at least an appropriate signaling connection control part (SCCP) subsystem numbers (SSNs) or the suggested mobile application part (MAP) versions, if selected, from the one or more software wizards are saved.

20. The computer implemented method of claim 13, can be performed manually, automatically and in a combination of both.
